(19) United States
(12) Patent Application Publication
(10) Pub. No.: US 2007/0164998 A1
(43) Pub. Date: Jul. 19, 2007

(54) Invisible infrared laser mouse

(75) Inventor: Robert Chen, Kaoshung (TW)

Correspondence Address: BIRCH STEWART KOLASCH & BIRCH, PO BOX 747, FALLS CHURCH, VA, 22040-0747, US

(73) Assignee: WIN-WIN OPTO-ELECTRONICS CO., LTD.

(21) Appl. No.: 11/332,165

(22) Filed: Jan. 17, 2006

(51) Int. Cl. G09G 5/08

(52) U.S. Cl. 345/166

(57) ABSTRACT

This invention is directed to a device of “Invisible Infrared Laser Mouse” characterized by fixing a light emitter and an image sensor at the inner open side of bottom shell; whereas the light emitter emits invisible infrared, and the image sensor is used to sense infrared. Accordingly, the invisible infrared emitted by the light emitter prevents human eyes from damage by high energetic laser beam and makes mouse more sensitive to gain the functions of protecting eyes, precise position, and steady cursor.

### BACKGROUND OF THE INVENTION

I. Field of the Invention

The present invention relates to a device of “Invisible Infrared Laser Mouse”, particularly refer to an optical mouse which possesses the functions of protecting eyes, precise cursor location, and steady cursor.

II. Description of the Prior Art

A conventional optical mouse comprises a light emitter, an image sensor, a lens, and a microprocessor. The light emitter projects visible laser light, while the combination of image sensor and lens is used to sense the visible laser light emitted by the light emitter. At the upside down of the mouse, a red light which can be seen emitted from its light emitter. The light emitter of conventional optical mouse projects visible laser light, that is, the visible laser light emitted by the light emitter reflects from desk surface (or other kinds of surface) back to the image sensor at the bottom of mouse, the microprocessor will analyze the image received from image sensor and judge the movement direction of the cursor (and transmit the direction signal to the personal computer).

However, because of the visible laser light emitted from the conventional optical mouse, the highest dosage yield of the visible laser light, and concentrate of emitted beam, the visible laser with-concentrating effects will hurt eyes and optic nerve of human beings and seriously influence the eyesight when directly peep into the emitter, especially in order to meet their curiosity about the visible light from emitter, children often inspect the emitter constantly, and damage eyesight permanently.

Additionally, please refer to the embodiment of FIG. 5, the light emitter a of conventional optical mouse projects light in parallel to surface level, and its light sensor b and lens c probe reflection light in perpendicular to the surface, it makes light sensor could only probe the blur reflection light from light emitter, and could not gather enough light to produce more clear image and better sense signal, and cause a less sensitive, ambiguous location, and unsteady mouse.

### SUMMARY OF THE INVENTION

It is therefore a primary object of the present invention to provide a device of “Invisible Infrared Laser Mouse.”

It is further object of the present invention to provide a device of “Invisible Infrared Laser Mouse” primary comprises a shell body, and characterized by: at the bottom of the shell body set up an opening with light emitter and image sensor at inner side, the direction of said light emitter arranges in a 45 degree slant angle, and a lens at the lower part of the image sensor with a slant angle from 5 to 10 degree designation. The light emitter is used to emit invisible infrared which is sensored by the image sensor.

Accordingly, the light emitter of the present invention “Invisible Infrared Laser Mouse” emits invisible infrared which avoids the possible damage to the curious and negligent children who directly look at the light from the light emitter; and owing to the angle of light emitter and lens are adjusted into a position that the most part of infrared from the light emitter can be directly reflected into the light sensor to attain the effects of protecting eyes, precise location, and steady cursor.

### BRIEF DESCRIPTION OF THE DRAWINGS

FIG. 1 The prospective view of the present invention

FIG. 2 The assembly prospective view of the present invention

FIG. 3 The bottom prospective view of the present invention

FIG. 4 The relational view of the present invention

FIG. 5 The relational view of the conventional mouse

### DETAILED DESCRIPTION OF PREFERRED EMBODIMENTS

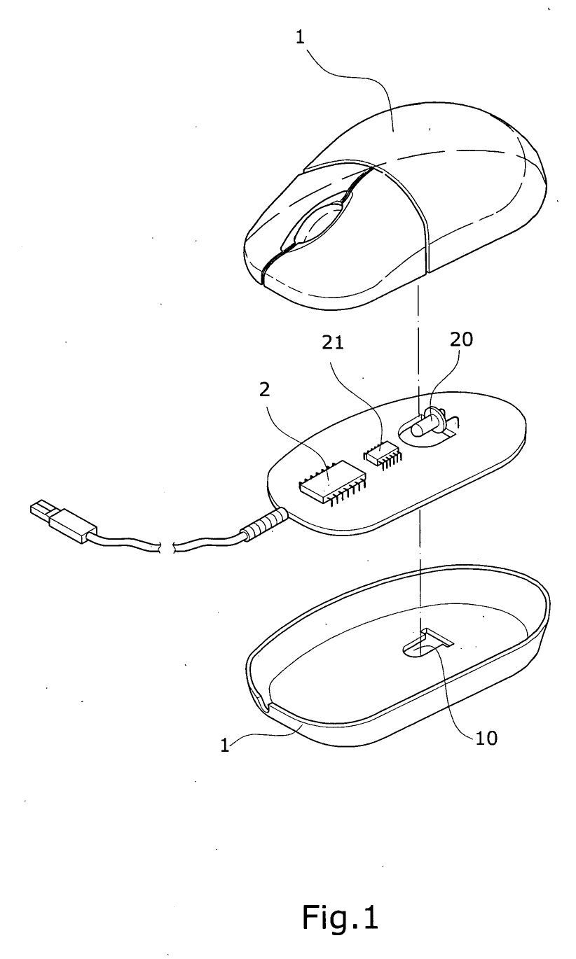

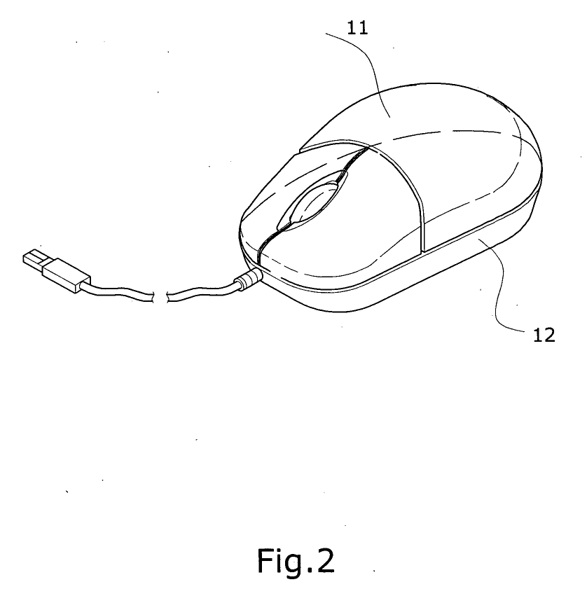

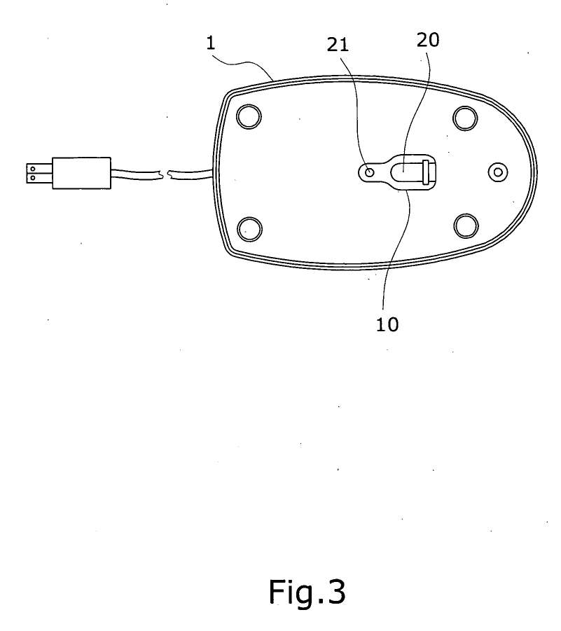

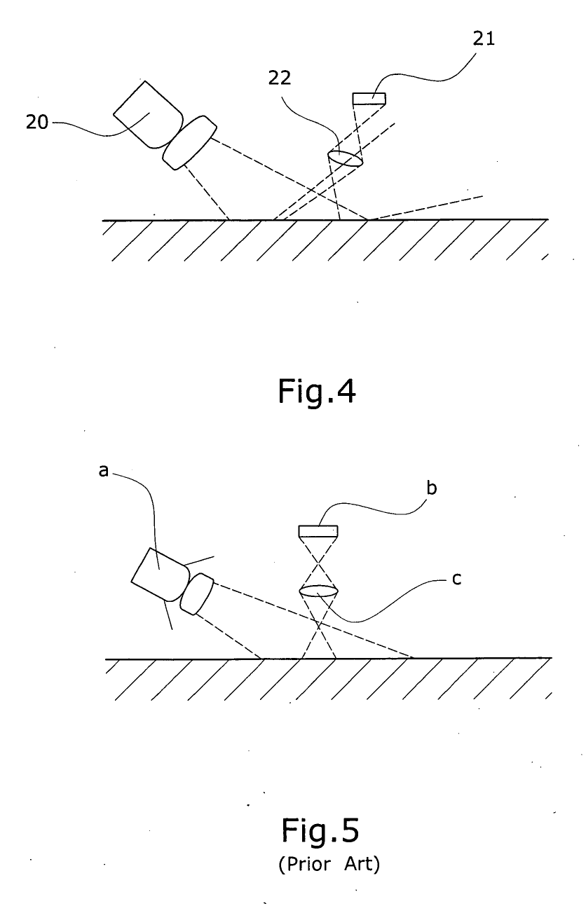

The embodiment modes of present invention will be explained in accordance with the accompanying drawings of FIG. 1 to FIG. 5.

First of all, referring to FIGS. 1, 2, 3, 4, the “Invisible Infrared Laser Mouse” in accordance with the present invention primarily includes an upper shell body 11, a bottom shell body 12, and a microprocessor 2, and characterized by:

The bottom shell body 12 set up an opening 10 with light emitter 20 and image sensor 21 at inner side of the opening, the direction of light emitter 20 arranges in a 45 degree slant angle, and a lens 22 fixes at the lower of the image sensor 21 in a slant angle from 5 to 10 degree designation. The light emitter 20 projects light out of the opening 10, the light beam projected by the light emitter 20 is invisible Infrared, while the light sensor 21 is used to sense the invisible infrared which is emitted by the light emitter.

Thereafter, the light beam projected by the light emitter 20 is invisible instead of visible light, and the infrared is a kind of infrared laser light beam. The so-called infrared invisible light, such as infrared (Infrared is called “a kind of light beyond red” means its spectrum is not within the vision zone of human eyes); as long as the light emitter 20 continuous to emit infrared laser beam which is invisible to human eyes; the light sensor 21 senses the laser light beam reflects from the desk surface (or other kinds of surface), then transfers the light to micro processor 2 arranged within the top shell 11 and bottom shell 12 for analysis and calculation to judge the movement of the mouse (and transmit the signal to the personal computer).

Consequently, the light emitter 20 of the present invention of “Invisible Laser Infrared” emits invisible laser infrared beam which cannot be found at the bottom of mouse by children, avoid damage to children's eyes, and gain the effect of protecting eyes.

Furthermore, the light emitter of the present invention “Invisible Infrared Light Mouse” emits infrared in a 45 degree slant angle, and a lens 22 fixed in a slant angle from 5 to 10 degree designation so that most part of infrared could be reflected into image sensor directly, and makes image sensor gather enough infrared to get a clear image to produce correct sense signal, precise location and steady cursor.

In summary, the present invention is related to a device of invisible infrared laser mouse which possess the effects of protecting eyes, precise location, and steady cursor.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

What is claimed is:

1. A structure of “Invisible Infrared Laser Mouse” mainly consists of a upper shell, a lower shell and a microprocessor, and characterized by:
An opening set up at the bottom surface of bottom shell with light emitter and image sensor at inner side of the opening, the direction of light emitter arranged in a 45 degree slant angle, and a lens fixed at the lower of the image sensor in a slant angle from 5 to 10 degree designation. The light emitter projects light out of the opening, the light beam projected by the light emitter is invisible infrared, while the light sensor was used to sense the invisible infrared which is emitted by the light emitter.

2. The device of “Invisible Infrared Laser Mouse” of claim 2, wherein infrared invisible light is a kind of infrared laser light.
